(19) United States
(12) Patent Application Publication
(10) Pub. No.: US 2013/0271472 A1
(43) Pub. Date: Oct. 17, 2013

(54) Display of Value Changes in Between Keyframes in an Animation Using a Timeline

(71) Applicant: Jonathan M. Duran, Benicia, CA (US)

(72) Inventor: Jonathan M. Duran, Benicia, CA (US)

(73) Assignee: Motorola Mobility, Inc., Libertyville, IL (US)

(21) Appl. No.: 13/445,527

(22) Filed: Apr. 12, 2012

(51) Int. Cl. G06T 13/00

(52) U.S. Cl. 345/473

(57) ABSTRACT

In one embodiment, a method includes receiving a first input used to determine a plurality of keyframes in an interface used to create an animation of an element. Each keyframe in the plurality of keyframes is associated with a value. The method then calculates, for a set of frames in between at least two keyframes in the plurality of keyframes, a value for each frame in the set of frames. The value for each frame in the set of frames is stored in a data structure. A second input associated with a time in between the at least two keyframes is received from the interface being used to create the animation. The method then determines a frame in the set of frames based on the time and the value associated with the frame from the data structure and renders the element using the value.

### BACKGROUND

A user may use an authoring application to create an animation. The authoring application creates software code that can be used by a browser to play the animation. For example, hypertext transfer markup language (HTML) software code and cascade style sheets (CSS) software code are created for the animation. The HTML software code may define an element that is being animated and the CSS software code applies the animation to the element. For example, the user defines keyframes in the authoring application at different times. Each keyframe is associated with a different value that is used to create an animation. For example, if an animation of a bouncing ball is created, then the user defines pixel values for positioning of the bouncing ball at different keyframes using the authoring application.

An example of CSS software code is shown in FIG. 1. Keyframes are defined at percentages of the duration of the animation. For example, at 102, keyframes have been defined at 0%, 50%, and 100% during the duration of the animation. At 104, for each keyframe, a pixel value is defined. For example, at the 50% mark of the animation, a bouncing ball is at the pixel position of “100 px; 100 px”. The position may be x-y coordinates. Then, at 100% of the duration of the animation, the bouncing ball is at the pixel position of “50 px: 50 px”. The CSS software code only includes the values for the keyframes that are defined, such as the 0%, 50%, and 100% keyframes.

If a user wants to preview the animation, the HTML software code and CSS software code needs to be executed in a browser. Because only three values are defined for the positioning of the bouncing ball during the animation, the browser interprets the values in between the keyframes. For example, between 0% and 50%, the browser would calculate the position of the bouncing ball for various frames between the 0% and 50% keyframes. Additionally, the browser would calculate the position of the ball for frames between the 50% and 100% keyframes. The browser calculates these values at runtime. Thus, to preview the animation, the HTML code and CSS code are run in the browser. During execution, the browser interprets the positioning of the bouncing ball in between the keyframes and plays the animation.

### SUMMARY

In one embodiment, a method includes receiving a first input used to determine a plurality of keyframes in an interface used to create an animation of an element. Each keyframe in the plurality of keyframes is associated with a value. The method then calculates, for a set of frames in between at least two keyframes in the plurality of keyframes, a value for each frame in the set of frames. The value for each frame in the set of frames is stored in a data structure. A second input associated with a time in between the at least two keyframes is received from the interface being used to create the animation. The method then determines a frame in the set of frames based on the time and the value associated with the frame from the data structure and renders the element using the value.

In one embodiment, a non-transitory computer-readable storage medium is provided containing instructions for controlling a computer system to be operable to: receive a first input used to determine a plurality of keyframes in an interface used to create an animation of an element, wherein each keyframe in the plurality of keyframes is associated with a value; calculate, for a set of frames in between at least two keyframes in the plurality of keyframes, a value for each frame in the set of frames; store the value for each frame in the set of frames in a data structure; receive a second input associated with a time in between the at least two keyframes from the interface being used to create the animation; determine a frame in the set of frames based on the time and the value associated with the frame from the data structure; and render the element using the value.

In one embodiment, an apparatus is provided comprising: one or more computer processors; and a computer-readable storage medium comprising instructions for controlling the one or more computer processors to be operable to: receive a first input used to determine a plurality of keyframes in an interface used to create an animation of an element, wherein each keyframe in the plurality of keyframes is associated with a value; calculate, for a set of frames in between at least two keyframes in the plurality of keyframes, a value for each frame in the set of frames; store the value for each frame in the set of frames in a data structure; receive a second input associated with a time in between the at least two keyframes from the interface being used to create the animation; determine a frame in the set of frames based on the time and the value associated with the frame from the data structure; and render the element using the value.

The following detailed description and accompanying drawings provide a more detailed understanding of the nature and advantages of the present invention.

### BRIEF DESCRIPTION OF THE DRAWINGS

FIG. 1 shows an example of CSS software code.

FIG. 2 depicts an example of a computing device for creating and previewing animations according to one embodiment.

FIG. 3 depicts an example of an interface according to one embodiment.

FIG. 4 depicts an example of previewing the animation using an authoring application according to one embodiment.

FIG. 4 depicts an example of previewing the animation using the authoring application according to one embodiment.

FIG. 5 shows an example of a matrix according to one embodiment.

FIG. 6 depicts a simplified flowchart for calculating values shown in matrix 214 according to one embodiment.

FIG. 7 depicts a simplified flowchart of a method for providing the preview of the animation according to one embodiment.

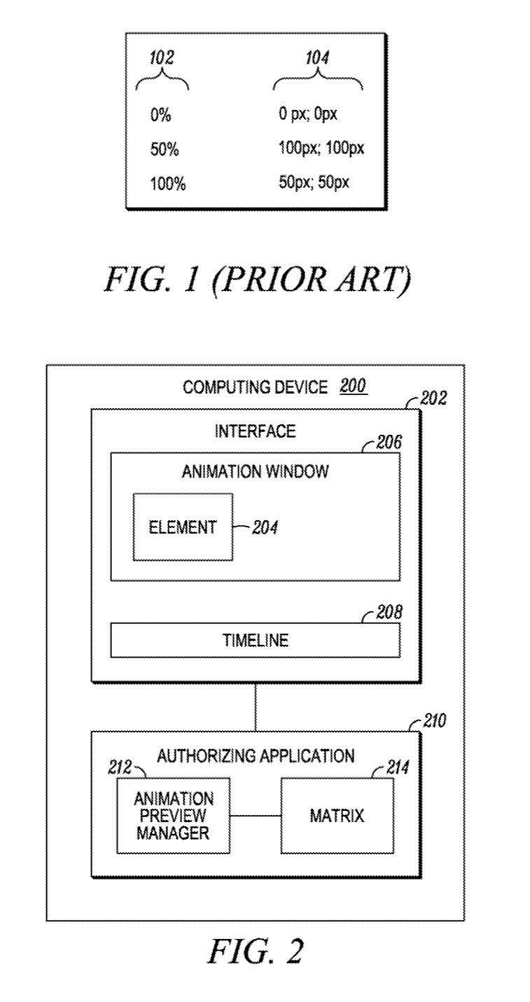

### DETAILED DESCRIPTION

Described herein are techniques for an animation system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

FIG. 2 depicts an example of a computing device 200 for creating and previewing animations according to one embodiment. Computing device 200 includes an interface 202 and an authoring application 210 that is used to create an animation. Authoring application 210 may be included in computing device 200 or the functions may be distributed, such as on a server (not shown) communicating with computing device 200.

An element 204 may be created in an animation window 206. A user may use an authoring application 210 to create an animation by setting properties of element 204 and selecting a time on a timeline 208. The selected time is referred to as a “keyframe”. The keyframe is one frame in the created animation and is associated with a set of property values.

Element 204 may be various shapes, text, or other objects that can be animated. Element 204 may be associated with a software language, such as an HTML. The animation is created by manipulating different properties of element 204. For example, the position of element 204 may be changed in the animation. In other examples, the color, the shape, or other properties, are changed to create the animation.

During creation of the animation, authoring application 210 receives user input setting a value for a property associated with element 204. For example, element 204 may be moved to a position in window 206. Then, authoring application 210 receives a user input on timeline 208 indicating a time in which the value associated with element 204 should be applied in the animation. Then, authoring application 210 creates a keyframe that is associated with the value. In one example, the animation may move element 204 across window 206 during a time duration, such as 10 seconds. A user can set the position at certain times during the animation by creating keyframes. As the user sets keyframes, authoring application 210 creates software code defining the property values for the keyframes. For example, CSS code may be created for element 204.

As will be discussed in more detail below, particular embodiments allow a user to preview the animation in authoring application 210 (or another interface) by pre-calculating values for frames in between keyframes. For example, an animation preview manager 212 determines frames between keyframes and calculates the values of properties for those frames. These values are stored in a data structure, such as a matrix 214.

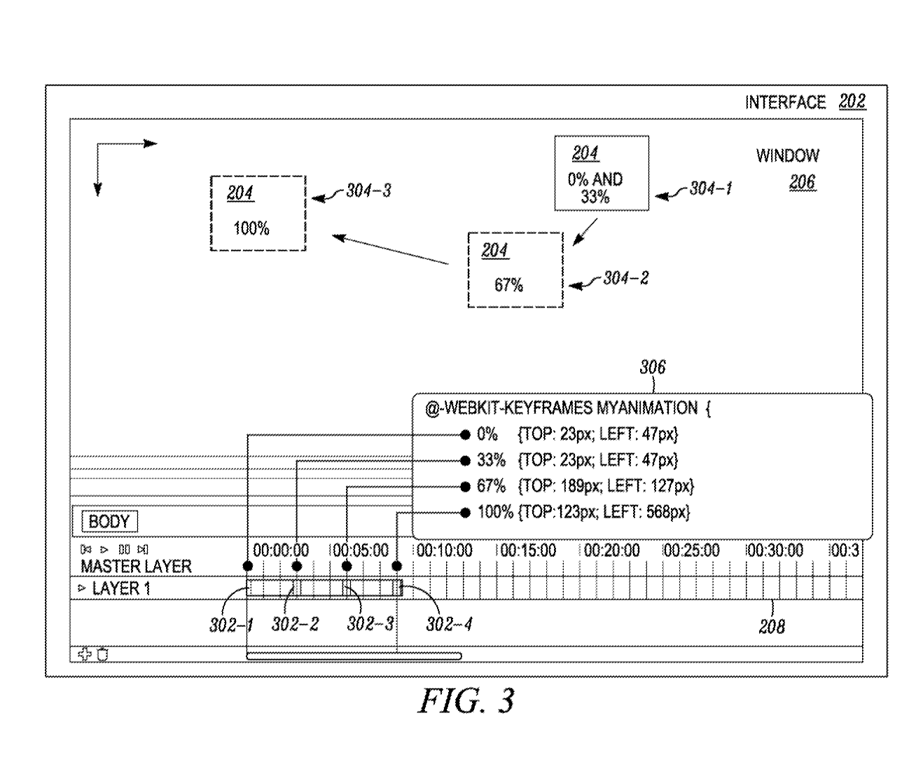

FIG. 3 depicts a more detailed example of interface 202 according to one embodiment. On timeline 208, four keyframes 302-1-302-4 have been created. For example, a user may have selected keyframes 302 on timeline 208. Although an explicit selection by a user may be received to create a keyframe 302, authoring application 210 may also create a keyframe 302 automatically. For example, keyframe 302-1 may be created automatically to indicate the beginning of the animation when another keyframe 302 is created.

Authoring application 210 creates CSS code for keyframes 302 that is shown at 306. The CSS code is displayed for illustrative purposes and may be not actually displayed on interface 202. The keyframes are associated with a percentage of the duration of the animation. For example, keyframes at 0%, 33%, 67%, and 100% correspond to keyframes 302-1, 302-2, 302-3, and 302-4, respectively.

In this animation, element 204 is moved across window 206. To create the animation, a user would move element 204 to different positions in window 206 and then select a keyframe 302 (e.g., a time) on timeline 208. At a keyframe 302-1, element 204 is shown at a position 304-1. CSS software code is created for this keyframe at the 0% duration of the animation. As shown in 306, the position property is set at a value of “top: 23 px; left: 47 px”, which is the position of element 204 in pixel values in window 206. For a keyframe 302-2, the position of element 204 remains unchanged and is shown at position 304-1 in window 206. In this case, the property values have been held and the animation does not begin right away. As shown at 306, the value of the position property remains unchanged for keyframe 302-2 (33% duration).

At a position 304-2, element 204 has been moved to a different position in window 206. Authoring application 210 receives a user input for creating a keyframe 302-3 on timeline 208 from the user. This indicates that at 67% of the duration of the animation, a position of element 204 should be “top: 189 px; left: 127 px”.

Element 204 is then moved to a position 304-3 in window 206. Authoring application 210 receives user input to create a keyframe 302-4 on timeline 208. This sets the position of element 204 as “top: 123 px; left: 568 px”.

A user may wish to preview the created animation using authoring application 210. For example, a user may want to preview the animation at certain times during the animation. As discussed above, conventionally, HTML code and the CSS code shown at 306 in FIG. 3 would need to be executed by a browser to preview the animation. However, a user can preview the animation in authoring application 210 (or another interface) because authoring application 110 pre-calculates values for frames in between keyframes 302. For example, animation preview manager 212 determines points between keyframes 302 and calculates the values of properties for those points. These values are stored in matrix 214. For example, matrix 214 may be an array that stores frames and associated values for the frames. Although a matrix is discussed, other data structures may also be used.

After calculating the values in between keyframes 302, when authoring application 210 receives a user input selecting a time on timeline 208, animation preview manager 212 may determine a frame that is closest to the time and looks up the values that were pre-calculated in matrix 214. The values are then applied to element 204 to render the element 204 in window 206. For example, element 204 may be moved to a position in window 206 associated with the time selected on timeline 208, which allows the user to preview the created animation at that time. Authoring application 210 provides the preview without executing the CSS software code for the animation.

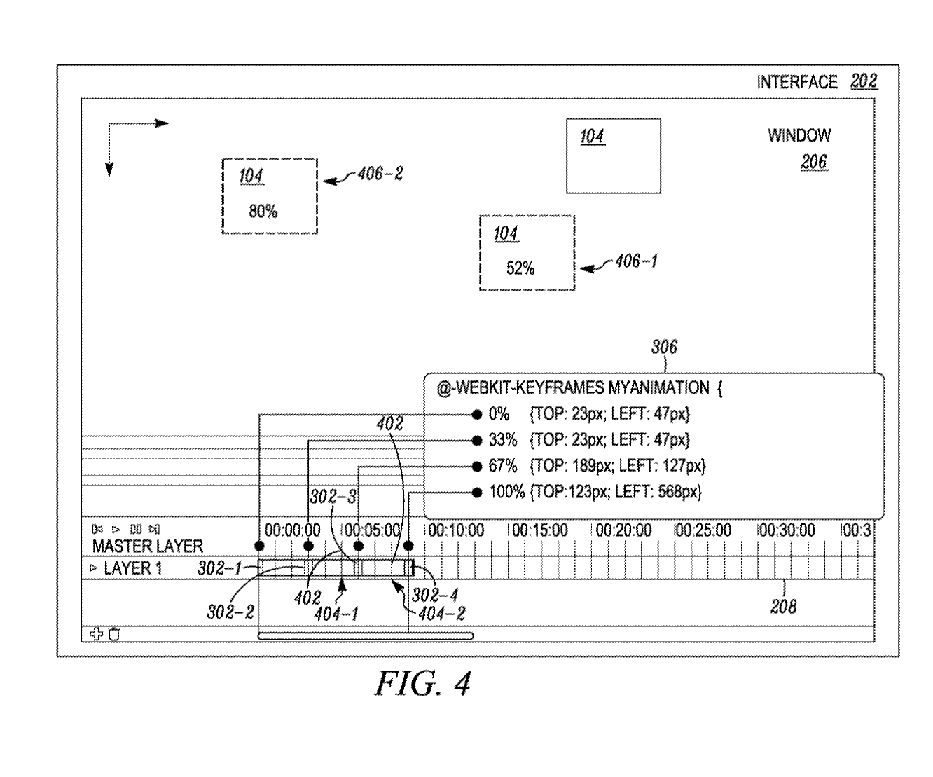

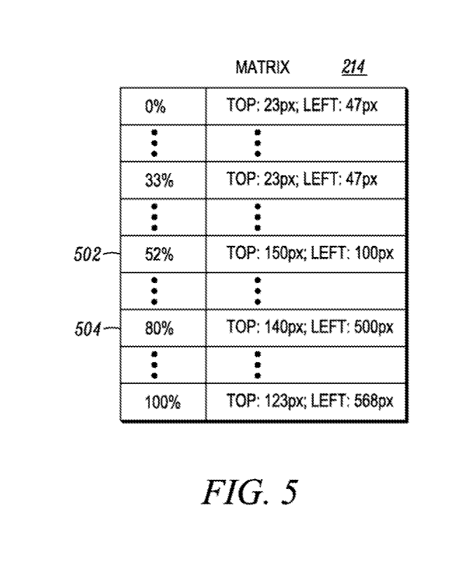

FIG. 4 depicts an example of previewing the animation using authoring application 210 according to one embodiment. A user may “scrub” timeline 208 to move a play head indicator 402 to different times within the duration of the animation. For example, at 404-1, a user has moved indicator 402 to a first position on timeline 208 in between keyframes 302-2 and 302-3. Animation preview manager 212 then determines indicator 402 is at a frame associated with a position of indicator 402. For example, animation preview manager 212 determines a frame associated with a 52% position within the duration of the animation. Animation preview manager 212 then determines the values in matrix 214 associated with this frame. For example, the position values may have been pre-calculated for this frame. FIG. 5 shows an example of matrix 214 according to one embodiment. As shown, various values between keyframes 302 are stored. For example, at 502 for a keyframe at 52%, the values of “top: 150 px; left: 100 px” are stored. Also, at 504, for the keyframe at 80%, the value of “top: 140 px; left: 500 px” is stored. Other values in between keyframes 302 may also be stored, but are not shown.

At 406-1, animation preview manager 212 displays element 204 in the position that was retrieved from matrix 214. This allows a user to preview where element 204 would be rendered at this point in time in timeline 208.

A user may then move indicator 402 to a position in timeline 208 shown at 402-2. This causes animation preview manager 212 to determine another frame associated with this position of indicator 402. For example, the frame may be associated with 80% of the duration of the animation. Animation preview manager 212 looks up the frame in matrix 214 and determines the values that were pre-calculated for that frame. At 406-2, element 204 has been moved to a position “top: 140 px; left: 500 px” indicated by the values looked up in matrix 214 for the 80% frame.

Accordingly, a user can preview the animation at different times that were not defined by keyframes 302 using authoring application 210. This allows the user to preview the animation without having to execute the HTML code and CSS code in the browser. Rather, authoring application 210 pre-calculates values for the frames in between keyframes 302 and stores those values in matrix 214. Thus, a preview can be provided to a user without executing the created HTML code and/or CSS code and in the same interface being used to create CSS software code.

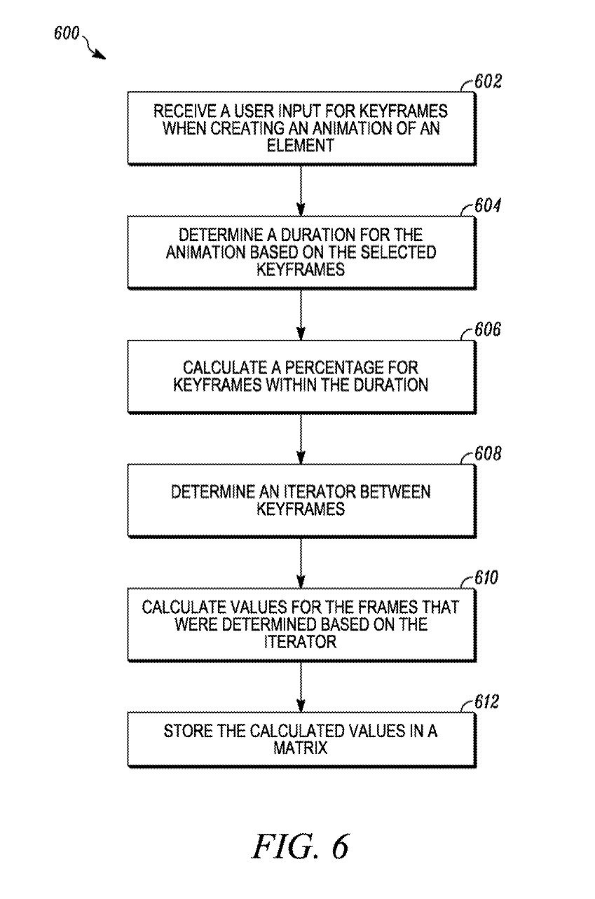

FIG. 6 depicts a simplified flowchart 600 for calculating values shown in matrix 214 according to one embodiment. At 602, authoring application 210 receives a user input for keyframes 302 when creating an animation of element 204. At 604, animation preview manager 212 determines a duration for the animation based on the selected keyframes 302. The duration may change based on various inputs from a user. For example, a user may add keyframes 302 that extend the animation and the duration is calculated dynamically. Also, animation preview manager 212 may determine the duration when a user is finished creating the animation.

At 606, animation preview manager 212 calculates a percentage for keyframes 302 within the duration. Although a percentage is described, other ways of representing the position of keyframes 302 in the animation may be used. At 608, animation preview manager 212 determines an iterator between keyframes 302. For example, the number of frames in which to calculate for values in between keyframes 302 may vary. The iterator may define how many frames and associated values are calculated. The more frames in which values are calculated means a more accurate preview may be created.

At 610, animation preview manager 212 calculates values for the frames that were determined based on the iterator. For example, for each frame that was determined, animation preview manager 212 interpolates the value for the frame based on the values of keyframes 302. For example, if a frame is located in between keyframes 302 located at 33% and 67%, the values of those keyframes 302 are used to interpolate the value of the in-between frames. Any interpolation algorithm may be used to calculate the values. At 612, animation preview manager 212 stores the calculated values in matrix 214.

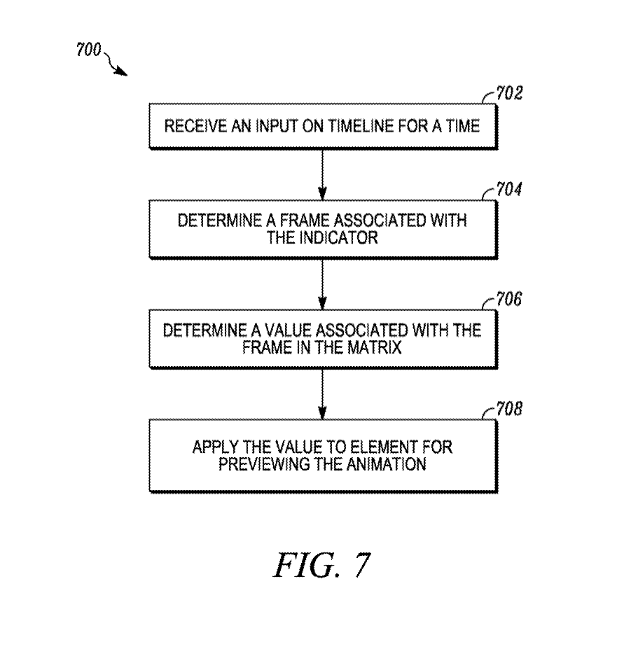

After calculating the values for the frames, a user may select different positions in timeline 208 to preview the animation. FIG. 7 depicts a simplified flowchart 700 of a method for providing the preview of the animation according to one embodiment. At 702, authoring application 210 receives an input on timeline 208 for a time. For example, a user may be moving indicator 402 along timeline 208 to different positions.

At 704, animation preview manager 212 determines a frame associated with indicator 402. At 706, animation preview manager 212 determines a value associated with the frame in matrix 214. For example, a frame that is closest to a time on timeline 208 is determined and the value associated with that frame is looked up in matrix 214.

At 708, animation preview manager 212 applies the value to element 204 for previewing the animation. For example, animation preview manager 212 renders element 204 in a position in interface 202. Other properties may also be changed, such as the color of element 204.

The above process may be performed dynamically as a user moves indicator 402 along timeline 208. Thus, a user may actively preview a created animation without executing the code created using authoring application 210.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
receiving a first input used to determine a plurality of keyframes in an interface used to create an animation of an element, wherein each keyframe in the plurality of keyframes is associated with a value;
calculating, for a set of frames in between at least two keyframes in the plurality of keyframes, a value for each frame in the set of frames;
storing the value for each frame in the set of frames in a data structure;
receiving a second input associated with a time in between the at least two keyframes from the interface being used to create the animation;
determining, by a computing device, a frame in the set of frames based on the time and the value associated with the frame from the data structure; and
rendering, by the computing device, the element using the value.

2. The method of claim 1, wherein the second input is received via a time line displaying the plurality of keyframes.

3. The method of claim 2, wherein:
the second input is received via moving of a play head indicator on the time line and the time is determined based on a position of the play head indicator; and
the frame that is determined is closest to the position of the play head indicator.

4. The method of claim 3, wherein as moving of the play head indicator is received at different times, the element is rendered using frames at the different times with values associated with the frames determined from the data structure.

5. The method of claim 1, wherein calculating comprises:
calculating a percentage of a duration for each keyframe in the plurality of keyframes;
determining the set of frames at percentages between the at least two keyframes; and
calculating a value for each of the set of frames based on a percentage associated with each frame and values for each of the at least two keyframes.

6. The method of claim 1, wherein:
the first input is used to create software code to perform the animation, and
the element is rendered without executing the created software code.

7. The method of claim 6, wherein the software code that is created comprises software code describing the animation at the keyframes.

8. The method of claim 1, wherein the value associated with the frame and the keyframes includes a property associated with the element.

9. A non-transitory computer-readable storage medium containing instructions for controlling a computer system to be operable to:
receive a first input used to determine a plurality of keyframes in an interface used to create an animation of an element, wherein each keyframe in the plurality of keyframes is associated with a value;
calculate, for a set of frames in between at least two keyframes in the plurality of keyframes, a value for each frame in the set of frames;
store the value for each frame in the set of frames in a data structure;
receive a second input associated with a time in between the at least two keyframes from the interface being used to create the animation;
determine a frame in the set of frames based on the time and the value associated with the frame from the data structure; and
render the element using the value.

10. The non-transitory computer-readable storage medium of claim 9, wherein the second input is received via a time line displaying the plurality of keyframes.

11. The non-transitory computer-readable storage medium of claim 10, wherein:
the second input is received via moving of a play head indicator on the time line and the time is determined based on a position of the play head indicator; and
the frame that is determined is closest to the position of the play head indicator.

12. The non-transitory computer-readable storage medium of claim 11, wherein as moving of the play head indicator is received at different times, the element is rendered using frames at the different times with values associated with the frames determined from the data structure.

13. The non-transitory computer-readable storage medium of claim 9, wherein calculate comprises:
calculate a percentage of a duration for each keyframe in the plurality of keyframes;
determine the set of frames at percentages between the at least two keyframes; and
calculate a value for each of the set of frames based on a percentage associated with each frame and values for each of the at least two keyframes.

14. The non-transitory computer-readable storage medium of claim 9, wherein:
the first input is used to create software code to perform the animation, and
the element is rendered without executing the created software code.

15. The non-transitory computer-readable storage medium of claim 14, wherein the software code that is created comprises software code describing the animation at the keyframes.

16. The non-transitory computer-readable storage medium of claim 9, wherein the value associated with the frame and the keyframes includes a property associated with the element.

17. An apparatus comprising:
one or more computer processors; and
a computer-readable storage medium comprising instructions for controlling the one or more computer processors to be operable to:
receive a first input used to determine a plurality of keyframes in an interface used to create an animation of an element, wherein each keyframe in the plurality of keyframes is associated with a value;
calculate, for a set of frames in between at least two keyframes in the plurality of keyframes, a value for each frame in the set of frames;
store the value for each frame in the set of frames in a data structure;
receive a second input associated with a time in between the at least two keyframes from the interface being used to create the animation;
determine a frame in the set of frames based on the time and the value associated with the frame from the data structure; and
render the element using the value.

18. The apparatus of claim 18, wherein the second input is received via a time line displaying the plurality of keyframes.

19. The apparatus of claim 18, wherein calculate comprises:
calculate a percentage of a duration for each keyframe in the plurality of keyframes;
determine the set of frames at percentages between the at least two keyframes; and
calculate a value for each of the set of frames based on a percentage associated with each frame and values for each of the at least two keyframes.

20. The apparatus of claim 18, wherein:
the first input is used to create software code to perform the animation, and
the element is rendered without executing the created software code.
